(19) United States
(12) Patent Application Publication
(10) Pub. No.: US 2013/0342835 A1
(43) Pub. Date: Dec. 26, 2013

(54) TIME RESOLVED LASER RAMAN SPECTROSCOPY USING A SINGLE PHOTON AVALANCHE DIODE ARRAY

(71) Applicant: Jordana Blacksberg, La Canada, CA (US)

(72) Inventor: Jordana Blacksberg, La Canada, CA (US)

(73) Assignee: California Institute of Technology, Pasadena, CA (US)

(21) Appl. No.: 13/925,883

(22) Filed: Jun. 25, 2013

Related U.S. Application Data
(60) Provisional application No. 61/663,948, filed on Jun. 25, 2012.

(51) Int. Cl. G01J 3/28; G01J 3/44

(52) U.S. Cl. CPC G01J 3/2803; G01J 3/44
USPC 356/301; 356/300; 356/318

(57) ABSTRACT

A Raman spectrometer that employs a time-gated single photon avalanche diode array as a sensor is described. The spectrometer can also perform fluorescence spectroscopy and laser induced breakdown spectroscopy (LIBS). A laser is used to provide an excitation signal to excite a specimen of interest. A spectrometer is used to separate the various intensities over a range of wavelengths, which are then caused to impinge on the array to be recorded. The time-gated single photon avalanche diode array is triggered in synchrony with the excitation signal so as to allow time resolution of the response of the sample of interest to the excitation. The array can be time-gated to resolve signals that have shorter durations as a function of time while excluding signals that have a longer time duration. Raman and LIBS signals can be observed even from specimens that fluoresce strongly.

### CROSS-REFERENCE TO RELATED APPLICATIONS

This application claims priority to and the benefit of co-pending U.S. provisional patent application Ser. No. 61/663,948 filed Jun. 25, 2012, which application is incorporated herein by reference in its entirety.

### STATEMENT REGARDING FEDERALLY FUNDED RESEARCH OR DEVELOPMENT

The invention described herein was made in the performance of work under a NASA contract, and is subject to the provisions of Public Law 96-517 (35 USC 202) in which the Contractor has elected to retain title.

### THE NAMES OF THE PARTIES TO A JOINT RESEARCH AGREEMENT

NOT APPLICABLE.

### INCORPORATION-BY-REFERENCE OF MATERIAL SUBMITTED ON A COMPACT DISC

NOT APPLICABLE.

### FIELD OF THE INVENTION

The invention relates to spectroscopy in general and particularly to systems and methods that provide Raman spectra and laser-induced breakdown spectra (LIBS).

### BACKGROUND OF THE INVENTION

Since its discovery more than 80 years ago, and elevation 30 years later with the invention of the laser, Raman spectroscopy has evolved into the technique of choice for the in situ exploration of planetary bodies because it addresses a primary goal of mineralogical analysis: determination of structure and composition. With their high spectral and spatial resolution, laser Raman spectrometers for both surface and subsurface analysis are currently under development for a diverse set of planetary targets, including Mars and its moons Phobos and Deimos, Venus, Earth's moon, and asteroids. Localized analyses of planetary surfaces using laser Raman spectroscopy complement global satellite remote sensing using visible-infrared imaging from orbit and are the prime consideration for preselection of rock samples prior to caching for potential sample return missions. Applications in terrestrial settings are also known. As the technique has become ever more sensitive, previously inaccessible applications have emerged, for example, in nanomaterials, art and archaeology, biological and medical sciences, as well as in planetary science.

Raman spectroscopy is fast, non-destructive, can provide phase identification for most crystalline materials, and in many cases, can provide significant compositional information. The laser source can be focused to a very small spot size (˜1-5 μm) comparable to mineralogical grains. Raman spectroscopy lends itself easily to combination with microscopic imaging, retaining the context of the natural mineral setting.

One issue that can limit the application of Raman spectroscopy is interference from unwanted background fluorescence, which is often much larger than the Raman signatures of interest. An effective solution is time-resolved Raman spectroscopy, which can detect Raman signatures under all fluorescence conditions. Since Raman emission is virtually instantaneous, while fluorescence occurs over longer time scales, a fast time-resolved detector can be used to distinguish spectra from both processes. The use of streak cameras is known in the field.

We have previously developed a time resolved Raman and fluorescence spectrometer using a streak camera. Using this technology we have demonstrated the ability to separate Raman and fluorescence using time resolution on a variety of relevant Mars analog minerals (J. Blacksberg, G. Rossman, A. Gleckler, Applied Optics, 49 (26), pp. 4951-4962, 10 September, 2010).

Problems associated with using a streak camera include size, cost and complexity of the apparatus.

There is a need for improved apparatus for performing Raman and LIBS spectroscopy.

### SUMMARY OF THE INVENTION

According to one aspect, the invention features a time-gated spectroscopy apparatus. The time-gated spectroscopy apparatus comprises an illumination source configured to provide an optical excitation signal to excite a specimen of interest so as to generate an optical response signal; a trigger signal source configured to provide a trigger signal in synchrony with the optical excitation signal; a spectrometer configured to receive the optical response signal and to provide the optical response signal in a wavelength-dispersed format; a single photon avalanche diode array configured to receive the optical response signal in the wavelength-dispersed format, configured to trigger in response to the optical trigger signal, and configured to provide an electrical output signal representative of a time-gated portion of the optical response signal in the wavelength-dispersed format; a signal recorder configured to record the electrical output signal; and a controller configured to control the illumination source, the single photon avalanche diode array, and the signal recorder, and configured to provide the recorded electrical output signal in the form of a spectrum output.

In one embodiment, the illumination source is a pulsed laser.

In another embodiment, the single photon avalanche diode array is configured to be triggered with a time resolution as short as tens of nanoseconds.

In yet another embodiment, the single photon avalanche diode array is configured to be triggered with a time resolution as short as units of nanoseconds.

In still another embodiment, the single photon avalanche diode array is configured to be triggered with a time resolution as short as picoseconds.

In a further embodiment, the controller is configured to provide the recorded electrical output signal in the form of a Raman spectrum.

In yet a further embodiment, the controller is configured to provide the recorded electrical output signal in the form of a laser-induced breakdown spectrum.

In an additional embodiment, the single photon avalanche diode array is an array having M×N pixels, where M and N are integers greater than 1.

In one more embodiment, the controller is a microprocessor-based controller.

In still a further embodiment, the microprocessor-based controller is selected from the group of controllers consisting of a FPGA, a general purpose programmable computer having instructions recorded on a machine readable medium, and a special purpose programmable computer having instructions recorded on a machine readable medium.

In one embodiment, the trigger signal is an electrical signal.

In another embodiment, the trigger signal is an optical signal.

According to another aspect, the invention relates to a time-gated spectroscopic method. The method comprises the steps of providing a specimen of interest from which a spectrum is desired; illuminating the specimen with an optical excitation signal; receiving an optical response signal from the specimen; converting the optical response signal to a wavelength-dispersed format; detecting the optical response signal in the wavelength-dispersed format in a single photon avalanche diode array that is triggered in synchrony with the optical excitation signal to provide an electrical output signal representative of a time-gated portion of the optical response signal in the wavelength-dispersed format; recording the electrical output signal; and providing the recorded electrical output signal in the form of a spectrum output.

In one embodiment, the illuminating is provided by a pulsed laser.

In another embodiment, the single photon avalanche diode array is configured to be triggered with a time resolution as short as tens of nanoseconds.

In yet another embodiment, the single photon avalanche diode array is configured to be triggered with a time resolution as short as units of nanoseconds.

In still another embodiment, the single photon avalanche diode array is configured to be triggered with a time resolution as short as picoseconds.

In a further embodiment, the recorded electrical output signal is provided in the form of a Raman spectrum.

In yet a further embodiment, the recorded electrical output signal is provided in the form of a laser-induced breakdown spectrum.

In an additional embodiment, at least one of the illuminating, receiving, converting, detecting, recording and providing the recorded electrical output signal in the form of a spectrum output steps is controlled by a microprocessor-based controller.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a schematic diagram of a prior art time-resolved Raman spectroscopy apparatus that uses a streak camera.

FIG. 1B is a schematic diagram of a time-resolved Raman spectroscopy apparatus that uses a single photon avalanche diode (SPAD) with optical triggering.

FIG. 1C is a schematic diagram of a time-resolved Raman spectroscopy apparatus that uses a single photon avalanche diode (SPAD) with electrical triggering.

FIG. 1D is a schematic diagram of a gated single-photon avalanche diode

FIG. 1E is a graph that illustrates the gating operation principle of a SPAD based on an active recharge technique.

FIG. 1F is a schematic timing diagram of the gated operation shown in FIG. 1E.

FIG. 2A illustrates 128×128 SPAD array image for a Willemite mineral sample taken with a gating of less than 33 ns.

FIG. 2B is a time resolved Raman spectrum generated by summing 30 columns in the image of FIG. 2A.

FIG. 3A illustrates a 128×128 SPAD array image for a Willemite mineral sample using a gate of greater than 1 μs.

FIG. 3B illustrates the resulting spectrum for the image of FIG. 3A, in which a Raman line is not well resolved.

FIG. 4 is a graph that compares Willemite spectra recorded using different detector types, including a CCD in CW Raman mode, a streak camera, and a SPAD.

FIG. 5A is a graph that shows Spodumene Raman spectra observed with gate times of 32 ns and >5 μs in comparison with a spectrum from the RRUFF database (taken at 785 nm to avoid fluorescence) which is shown for reference. The spectra are offset for clarity.

FIG. 5B is a 128×128 SPAD array image taken with a gate time of >5 μs for the Spodumene specimen.

FIG. 5C is a 128×128 SPAD array image taken with a gate time of 32 ns for the Spodumene specimen.

FIG. 6A is a Raman spectrum of Barite collected using the time-resolved laser spectrometer with the 128×128 SPAD array of FIG. 1B.

FIG. 6B is a LIBS spectrum of Barite collected using the time-resolved laser spectrometer with the 128×128 SPAD array of FIG. 1B.

FIG. 6C is a graph showing a series of LIBS spectra of Barite taken with the SPAD array spectrometer of FIG. 1B.

FIG. 7 is a schematic block diagram of a system that employs the time-resolved Raman spectroscopy apparatus that uses SPAD array spectrometer of FIG. 1B.

FIG. 8 is a flowchart that illustrates a method of making a time-gated spectrum using the s SPAD array spectrometer apparatus of FIG. 1B.

### DETAILED DESCRIPTION

We have demonstrated that time-resolved Raman spectroscopy is now achievable using an all-solid-state 128×128 SPAD detector array as an alternative to a Raman spectrometer that uses a streak camera. Replacing the streak camera with a SPAD detector allows for lower power dissipation, lighter weight and reduced complexity. A solid state detector is also expected to be more robust than a streak camera which contains a sealed tube and high voltage electronics. It is also expected to be more radiation hard. We also demonstrate the achievement of laser induced breakdown spectroscopy (LIBS) in the same instrument. It is believed that a SPAD design can achieve improved sensitivity over the streak camera. The 128×128 SPAD array used has been described by Y. Maruyama and E. Charbon, in Proceedings of the Transducers 11 Conference (IEEE, 2011), p. 1180. The effective fill factor is 4.5%, and a microlens array is used with a concentration factor of 1.59. Though not ideally designed for Raman spectroscopy, this chip was sufficient for demonstrating the feasibility of the approach. Other detectors, such as a 25×25 pixel SPAD, or a SPAD line detector, have also been used to demonstrate the method, as is briefly described later.

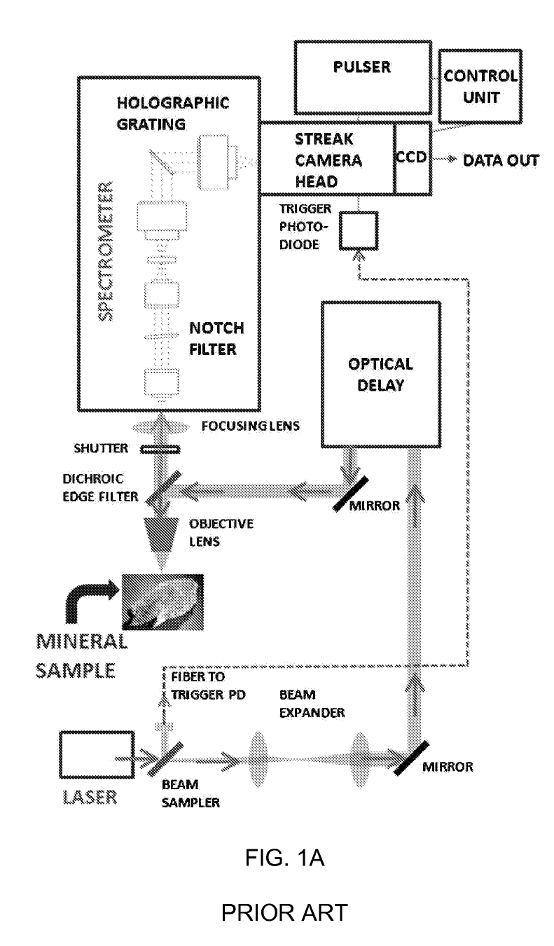

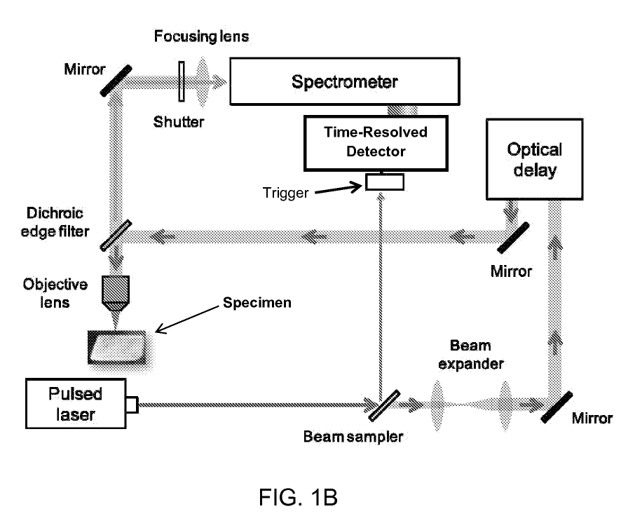

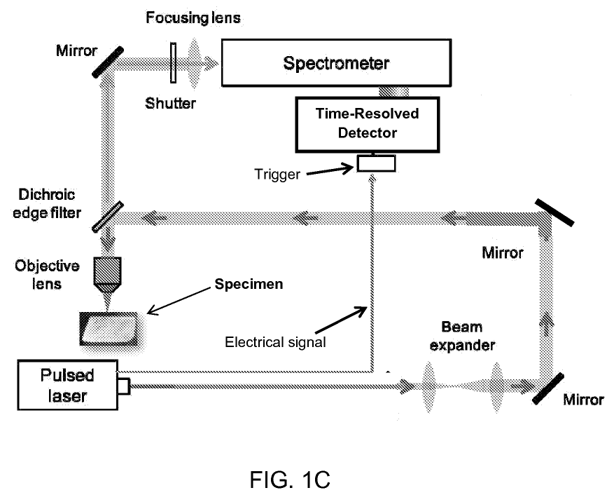

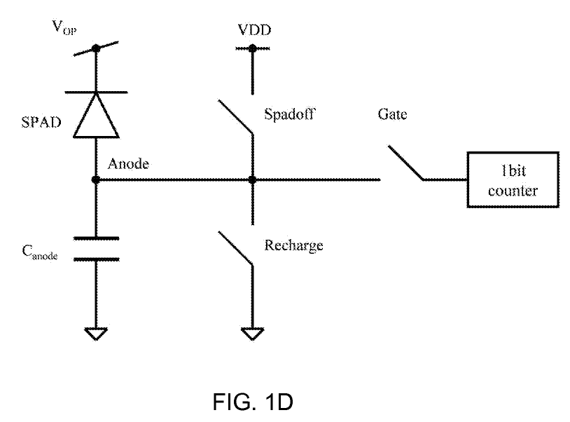

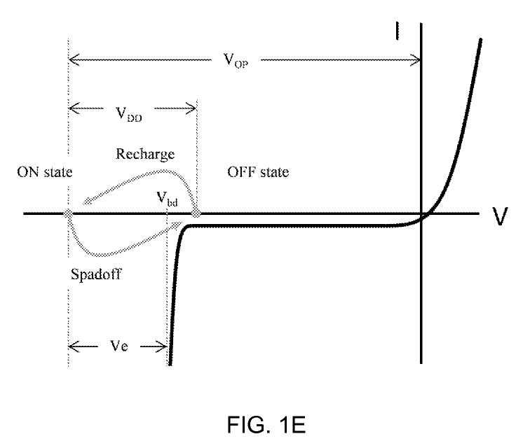

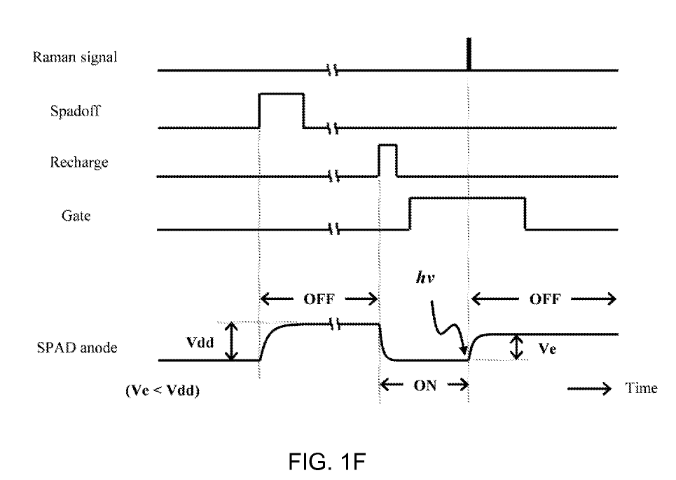

FIG. 1A is a schematic diagram of a prior art time-resolved Raman spectroscopy apparatus that uses a streak camera. A 532 nm passively Q-switched pulsed microchip laser (Arctic Photonics) delivers a 5 μJ pulse over ˜800 ps at a repetition rate of 1 kHz. A small portion (<1%) of the beam is sampled and delivered to a trigger photodiode, which triggers the streak camera to sweep. The main beam goes through an optical delay line timed to ensure that the Raman return is collected and synchronized with the camera. A dichroic edge filter reflects the laser light to an objective lens, which focuses the beam onto the mineral sample. The Raman/fluorescence return passes back through the dichroic and is focused onto the input slit of a modified Kaiser Optical Holospec spectrometer. Inside the spectrometer, a holographic notch filter cuts out the laser light again by ˜6 orders of magnitude. The light is focused onto a vertical slit prior to passing through a holographic grating, which spectrally disperses the light horizontally onto a 10 mm wide, 75 μm high slit that defines the entrance to a custom Axis Photonique streak camera using a Photonis P925 streak tube.

The streak camera collects data in synchroscan mode in which the laser is synchronized to the sweep electronics. The pulser electronics sweeps the spectrum vertically over a chosen time base, which can be varied from 4 ns to 500 μs. The streak camera repeatedly streaks small pulses across the phosphor screen, and the charge coupled device (CCD) integrates these pulses. The output on the CCD is a three-dimensional image with the spectrum on one axis, time on another axis, and intensity on the third axis. The benefit of this approach is that a small and inexpensive low pulse energy laser (microchip laser) can be used, and that we do not incur CCD read noise with every pulse, which significantly improves SNR. The front-end gain of the streak camera coupled with the low dark current and read noise of the CCD results in an extremely low total measured noise of <2 photons per minute. Because only the return is synchronized with the laser, background light is eliminated (allowing for daylight operation) along with unwanted fluorescence. As a result, a pulsed system operating at the same average laser power as a continuous wave (CW) system can achieve a given Raman peak signal-to-noise ratio (SNR) in a shorter collection time.

An objective lens is used to focus the beam onto the mineral sample. The Raman return is collected in the 180° configuration back through the objective lens. A set of objective lenses of 4× (4 power), 10× (10 power), and 40× (40 power) were used. The data presented here were acquired with the 40× objective, which has the highest numerical aperture (NA), but also the shortest working distance.

FIG. 1B is a schematic diagram of a time-resolved Raman spectroscopy apparatus that uses a single photon avalanche diode (SPAD) with optical triggering. The SPAD apparatus replaces the streak camera and its control circuitry with a detector based on a SPAD and the control circuitry used to operate that device. Optical delay can be incorporated in the instrument circuitry in order to synchronize the timing of the detection with the firing of laser.

FIG. 1C is a schematic diagram of a time-resolved Raman spectroscopy apparatus that uses a single photon avalanche diode (SPAD) with electrical triggering. The optical excitation signal from the pulsed laser is directed to a beam expander to generate a laser beam of the desired diameter. The expanded laser beam is then focused onto a dichroic edge filter and into an objective lens to focus onto the sample. The Raman return signal, LIBS signal, and fluorescence signal of longer wavelength than the laser then pass through the dichroic edge filter and are sent to the spectrometer where they are spectrally dispersed onto the SPAD array. The spectrally dispersed components are separated in time by the SPAD array. An electrical signal is sent to the SPAD trigger in synchrony with the firing of the laser. In some embodiments, this electrical trigger signal is generated by the laser and is a standard feature on many pulsed lasers. In other embodiments, the equipment that pulses the laser also provides the electrical signal sent to the SPAD trigger, or can be used to trigger the SPAD. Electronic delay (or time offset) can be incorporated in the instrument circuitry in order to synchronize the timing of the detection with the firing of the laser. The electronic delay can be variable. In particular, if the optical path lengths are known, or can be measured, the appropriate delay can be calculated and can be provided.

A single-photon avalanche diode (SPAD) (also known as a Geiger-mode APD or G-APD) is a solid-state photodetector in which a photo-generated carrier can trigger an avalanche current due to the impact ionization mechanism. This device is able to detect low intensity signals (down to the single photon) and to signal the arrival times of the photons with a jitter of a few tens of picoseconds. SPADs, like avalanche photodiodes (APDs), exploit the photon-triggered avalanche current of a reverse biased p-n junction to detect an incident radiation. The fundamental difference between SPAD and APD is that SPADs are specifically designed to operate with a reverse-bias voltage well above the breakdown voltage.

In operation a SPAD is reverse biased above its breakdown voltage, V_{bd}, where the detector's optical gain is virtually infinite. To prevent permanent damage to the pn junction or wiring, a resistance is commonly used to passively quench the avalanche. Therefore, the SPAD creates a short voltage pulse per avalanche event and runs in a time-uncorrelated manner. In one embodiment, three switches are implemented to achieve time-resolved photon detection as shown in FIG. 1D, which is a schematic diagram of a gated single-photon avalanche diode.

FIG. 1E is a graph that illustrates the gating operation principle of a SPAD using an active recharge technique. The SPAD anode voltage can be modulated from V_{DD} to GND by alternately switching ‘Spadoff’ and ‘Recharge’. Therefore, the net voltage applied to the pn junction can be set Vₑ above breakdown voltage V_{bd} resulting in an optical gain change from 1 to infinity, as illustrated in FIG. 1E.

When a photon hits the multiplication region at the pn junction during the ‘ON’ state, it creates an avalanche breakdown and the avalanche current charges up the anode capacitance C_{anode} to V_{bd}. The avalanche breakdown is eventually quenched. This voltage change is captured by subsequently opened ‘Gate’ switch as shown in FIG. 1F, which is a schematic timing diagram of the gated operation shown in FIG. 1E. When the photon hits the multiplication region during an ‘OFF’ state, it will not trigger an avalanche but just a small current that can be ignored by the system. To bring the pixel from an ‘OFF’ to an ‘ON’ state, it is necessary to recharge the device, i.e. to bring the pn junction from V_{bd} to V_{bd}+Vₑ, thus entering again a Geiger mode of operation. This operation is completed through the ‘Recharge’ transistor.

The all-solid-state 128×128 SPAD detector array used in obtaining time resolved Raman spectra can be fabricated in a 0.35 μm CMOS HV technology. The detector is used at the output of a Raman spectrometer as shown in FIG. 1B, allowing the observation of the entire Raman spectrum without the use of any moving parts. All necessary supply voltages are generated by a power module from a 25 V input supply voltage. In one embodiment, a Xilinx Spartan-3 FPGA and C++ software can be used to control the SPAD detector.

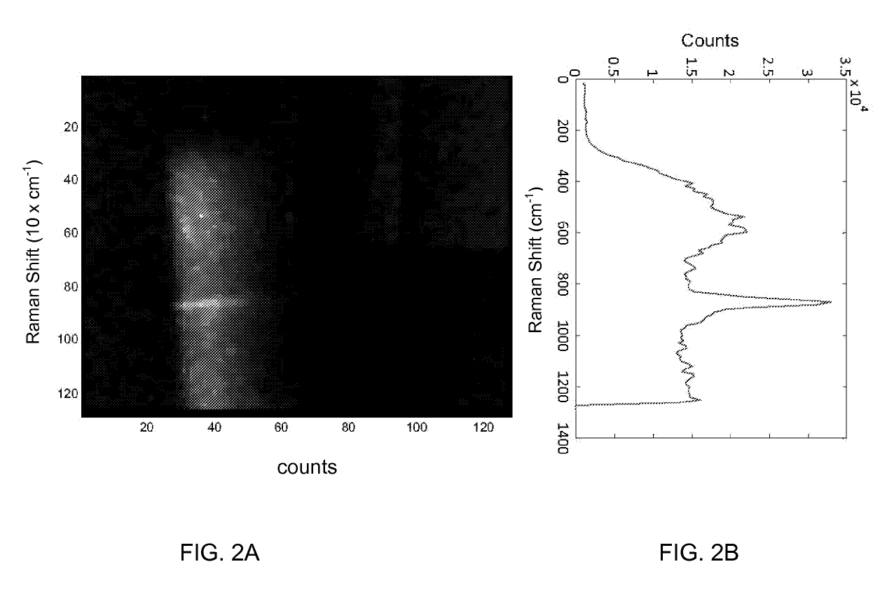

Table 1A gives some typical operating parameters for a SPAD detector used to record the 128×128 SPAD array image shown in FIG. 2A and the spectrum shown in FIG. 2B.

TABLE 1A

| Laser Wavelength | 532 | nm |
|---|---|---|
| Laser pulse energy | 1 | μJ/pulse |
| Laser pulse width | 500 | ps |
| Laser repetition rate | 40 | KHz |
| Chip speed | 40 | MHz |
| Time per frame | 409 | μs |
| Frames per measurement | 10,000 (typical) | |
| SPAD on time | 7:03 | ns |
| SPAD breakdown voltage | 19:1 | V |
| SPAD excess bias | 5 | V |

| | |
|---|---|
| SPAD Dark Count Rate (DCR) | 1830 Hz (at 5 V) |

We have more recently demonstrated an array of 1024×8 gated SPAD elements designed for time-resolved laser Raman spectroscopy and laser induced breakdown spectroscopy (LIBS). The new detector has better sensitivity and shorter time-gating performance as compared to the 128×128 SPAD array, as shown in Table 1B.

TABLE 1B

| Parameter | 128 × 128 SPAD array | 1024 × 8 SPAD array |
|---|---|---|
| PDE | 5% at Ve = 5 V | 19.3% at Ve = 5 V |
| Fill Factor | 4.5% | 44.0% |

| | | | |
|---|---|---|---|
| Pixel Pitch | 25 | μm | 24 μm |
| Gating Width | 30 | ns | 700 ps to ms range |

| | | |
|---|---|---|
| Gating Delay | external | 250 ps to ms range |
| DCR | 1830 Hz (at 5 V) | 5.7 kHz at Ve = 3 V |

### Willemite

Willemite is a trigonal zinc silicate mineral having the chemical formula Zn₂SiO₄ and a minor ore of zinc. Willemite is known for its strong green fluorescence peaked at 535 nm owing to the presence of Mn²⁺. The sample CIT1487 that was examined originated in Franklin, N.J. This mineral is highly fluorescent and provides a useful demonstration of the power of pulsed Raman under the most extreme fluorescence conditions.

FIG. 2A illustrates 128×128 SPAD array image for a Willemite mineral sample taken with a gating of less than 33 ns.

FIG. 2B is a time resolved Raman spectrum generated by summing 30 columns in the image of FIG. 2A.

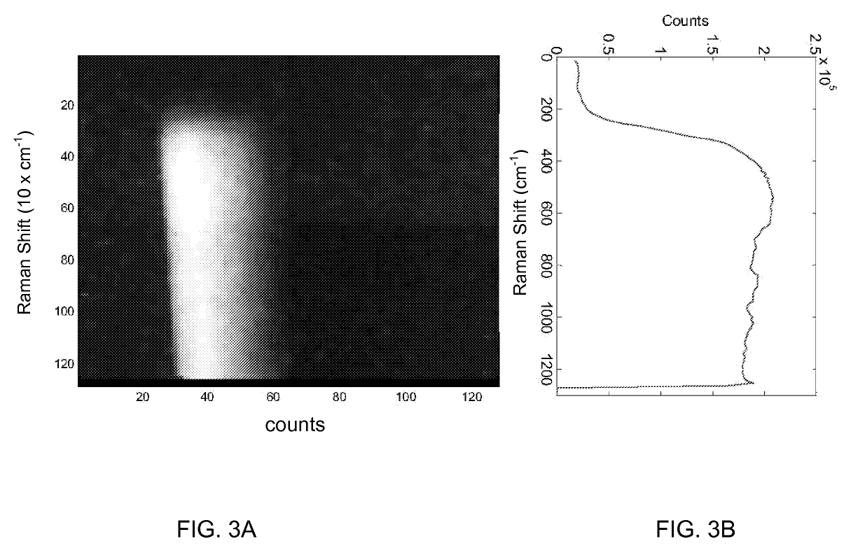

FIG. 3A illustrates a 128×128 SPAD array image for a Willemite mineral sample using a gate of greater than 1 ns.

FIG. 3B illustrates the resulting spectrum for the image of FIG. 3A, in which a Raman line is not well resolved. When the gate is lengthened to greater than 1 μsec Raman is no longer detectable but is overwhelmed by fluorescence.

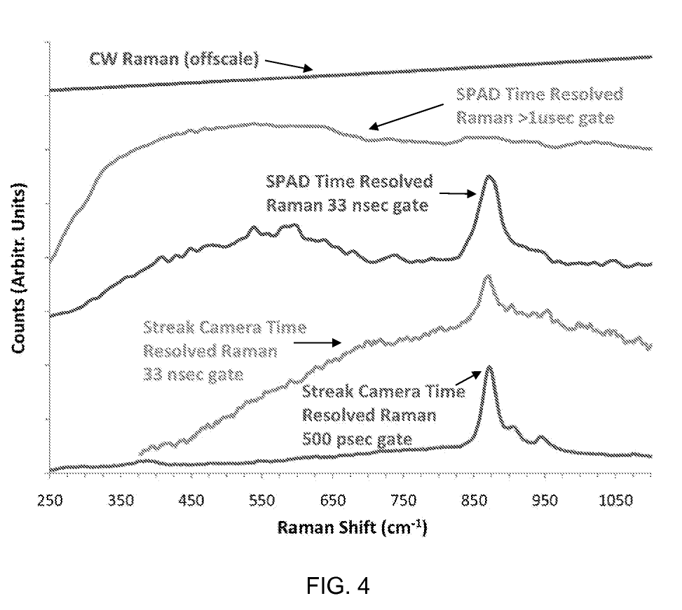

FIG. 4 is a graph that compares Willemite spectra recorded using different detector types, including a CCD in CW Raman mode, a streak camera, and a SPAD. As may be seen, the SPAD provides a Raman spectrum that is comparable to that obtained with a streak camera operating with the same gate time. As shown, the Raman spectrum from this sample was not measurable in the CW Raman system, even with only 1% of the laser power, due to saturation of the detector by fluorescence at all wavelengths. The time-resolved spectrum matches well with the RRUFF spectrum taken on an unoriented sample with a 785 nm excitation wavelength, which information is available from the RRUFF Project, Department of Geosciences, University of Arizona, 1040 E 4th, Tucson, Ariz., 85721-0077.

The CCD was saturated over the entire range due to fluorescence. The SPAD and streak camera results are comparable when taken over the same time scale (33 ns). As expected, the streak camera results with a shorter effective gate time (500 ps) show better signal to noise. In all cases, these spectra have not been calibrated for intensity variation versus wavelength, and fixed pattern noise from the detectors has not been subtracted out. The streak camera data were obtained with a high-resolution Raman grating and therefore show better spectral resolution than the SPAD data, which were obtained using a low-resolution broadband grating. This is not however a fundamental characteristic of the detector.

### Spodumene

Spodumene is a lithium aluminosilicate with the chemical formula LiAlSi₂O₆ that belongs to the pyroxene family of minerals. Spodumene is an important source of lithium for use in ceramics, mobile phone and automotive batteries, medicine and as a fluxing agent.

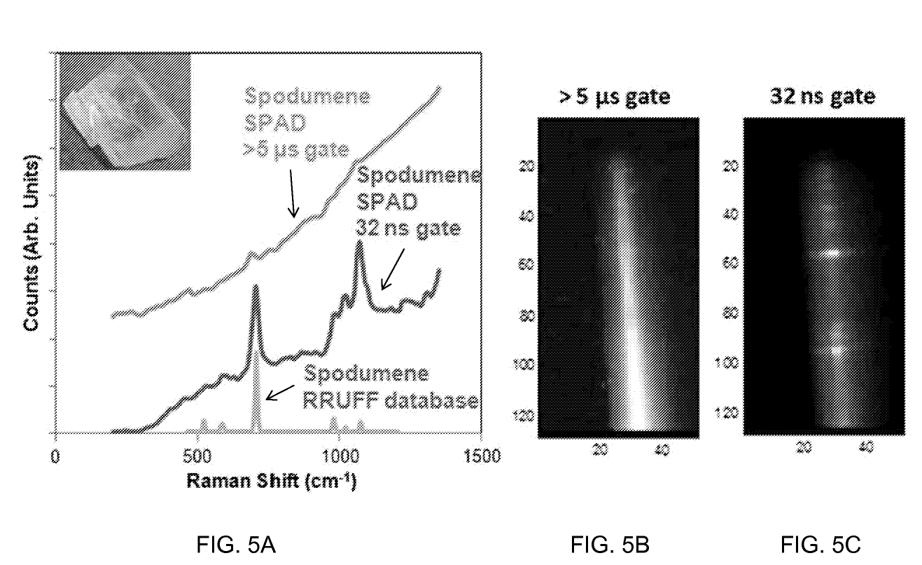

FIG. 5A is a graph that shows Spodumene Raman spectra observed with gate times of 32 ns and >5 μs in comparison with a spectrum from the RRUFF database (taken at 785 nm to avoid fluorescence) which is shown for reference. The spectra are offset for clarity.

FIG. 5B is a 128×128 SPAD array image taken with a gate time of greater than 5 μs for the Spodumene specimen.

FIG. 5C is a 128×128 SPAD array image taken with a gate time of 32 ns for the Spodumene specimen.

We have demonstrated the performance of the SPAD array for time-resolved Raman spectroscopy using two highly fluorescent natural mineral samples, Willemite (FIG. 2A, FIG. 2B) and Spodumene (FIG. 5A, FIG. 5B). When these samples were measured using a CW Raman spectrometer with a 514 nm laser and CCD detector, the spectra contained large fluorescence signals which saturated the detector, making Raman impossible to obtain. Willemite and Spodumene are both well known for their long-lifetime intense luminescence related to Mn2 [symbol] impurities. In both cases we acquired spectra using a short gate (32 ns) and a longer gate (greater than 1 μs). The short gate is necessary to detect Raman signatures in both of these samples. It is expected that the results would be improved even further by the use of shorter gate times.

### SPAD Array Characteristics

We determined the sensitivity of the SPAD array by measuring the laser power focused on the SPAD with the notch filter removed. Laser power was measured with a National Institute of Standards and Technology calibrated photodiode, and neutral density filters were used in the beam path to vary the incident power. The mean number of counts in a frame, as a function of the number of incident photons in a frame, was then determined and yielded a photon detection efficiency (PDE) of 5%. Given the fill factor and microlens concentration factor, this translates into a photon detection probability of 70%. We expect that the PDE can be improved by over an order of magnitude by increasing the fill factor and correcting an error in the fabrication of the microlens array, which caused almost a factor of 10 reduction in the concentration factor. The dark count rate (DCR) of the SPAD is extremely low (1830 Hz at 5 V excess bias). When considering that the SPAD is only active for 7 ns at a time, if the SPAD is synchronized with the 40 KHz laser (and not free running at 40 MHz as it is in the current chip), each frame would contain ˜10⁻⁴ dark counts. At this low level the DCR has almost no impact on sensitivity, even if the active pixel area were increased.

In comparing the results to those obtained with our streak camera system (which uses a PHOTONIS P925 streak tube), the PDE can be compared to the quantum efficiency (QE) of the photocathode, which increases from 5% to 10% from 620 to 532 nm. At longer wavelengths the QE decreases below 5%. Including optical coupling losses in our setup, we achieve an effective streak camera QE of only 2% to 3%. Accordingly, the sensitivity of the SPAD is already comparable to our streak camera, and we expect that we can improve it by over an order of magnitude by increasing the fill factor.

The exceptional time resolution of the SPAD is one of the characteristics that make this technology competitive for time-resolved Raman spectroscopy, where fluorescence lifetimes are often as short as nanoseconds in minerals. Our streak camera affords greater time resolution (˜20 ps) as well as the ability to collect the complete time evolution in a single image. However, using the present SPAD chip, 200 ps time resolution has been demonstrated for on-chip fluorescence-lifetime imaging microscopy (FLIM). A median FWHM instrument response function of this SPAD array is 230 ps over the entire array, which provides sufficient time resolution when combined with a 500 ps pulse width laser. Because of limitations related to synchronization between the single-pixel SPAD trigger chip and the 128×128 SPAD array, we were only able to demonstrate a minimum gate width of 32 ns. However, this is not a fundamental limitation, and it is expected that improved chip design will accommodate faster gating. It has been shown that the 128×128 SPAD array detector is capable of a time resolution of less than 200 picoseconds, which is unattainable using conventional solid state detectors (e.g. CCDs and CMOS detectors). The 128×128 SPAD array detector has the potential for very high sensitivity as well.

We have demonstrated the feasibility of obtaining high-sensitivity time-resolved Raman spectra using an SPAD array as an alternative to a streak camera. These results have utility in interplanetary instruments as well as numerous other applications such as geosciences, medicine, pharmaceuticals, and materials science.

In one embodiment, in which the SPAD detector had 25 μm×25 μm pixels, we used a Teem Photonics pulsed microchip laser with 1 μJ per pulse running at 40 KHz. The SPAD was synchronized with the laser using a single-pixel SPAD trigger chip. For demonstration purposes a broadband grating (spectrometer resolution ˜10 cm⁻¹) was used instead of a high resolution Raman grating (spectrometer resolution ˜1 cm⁻¹) in order to image a sizable portion of the Raman spectrum on the SPAD array, which is only 3:2 mm.

In another embodiment, SPAD line sensors can be used. See Table 2, which provides a performance summary of time-resolved SPAD line sensors that can be employed.

### Laser Induced Breakdown Spectroscopy (LIBS)

The ChemCam instrument package on the Curiosity rover (the Mars Science Laboratory) includes a Laser-Induced Breakdown Spectrometer (LIBS) which provides analysis of elemental compositions of specimens on the Martian surface. LIBS can target individual strata of a geological formation using its submillimeter beam diameter. The LIBS instrument uses powerful laser pulses, focused on a small spot on target rock and soil samples within 7 m of the rover, to ablate atoms and ions in electronically excited states from which they decay, producing light-emitting plasma that the spectrometer can detect and resolve. The power density needed for LIBS is greater than 10 MW/mm², which is produced on a spot in the range of 0.3 to 0.6 mm diameter using focused, ˜14 mJ laser pulses of 5 nanoseconds duration. The plasma light is collected by a 110 mm diameter telescope and focused onto the end of a fiber optic cable. The fiber carries the light to three dispersive spectrometers which record the spectra over a range of 240-850 nm at resolutions from 0.09 to 0.30 nm in 6144 channels. The spectra consist of emission lines of elements present in the samples. Typical rock and soil analyses yield detectable quantities of Na, Mg, Al, Si, Ca, K, Ti, Mn, Fe, H, C, O, Li, Sr, and Ba. Other elements often seen in soils and rocks on Earth include S, N, P, Be, Ni, Zr, Zn, Cu, Rb, and Cs. It is anticipated that the ChemCam instrument will require 50-75 laser pulses to achieve the desired 10% accuracy for major elements at 7 m distance. The spectrometer apparatus of the present invention would be a device that has no moving mechanical components, so that it would be expected to provide a more reliable spectrometer than that in ChemCam.

Increasing the pulse energy of a laser by about an order of magnitude as compared to that used for Raman spectroscopy creates a microscopic plasma near the surface of a sample and enables the collection of LIBS spectra at an unusually high repetition rate and low pulse energy.

### Barite

Barite is a mineral consisting of barium sulfate with the chemical formula BaSO₄. Barite is generally white or colorless, and is the main source of barium.

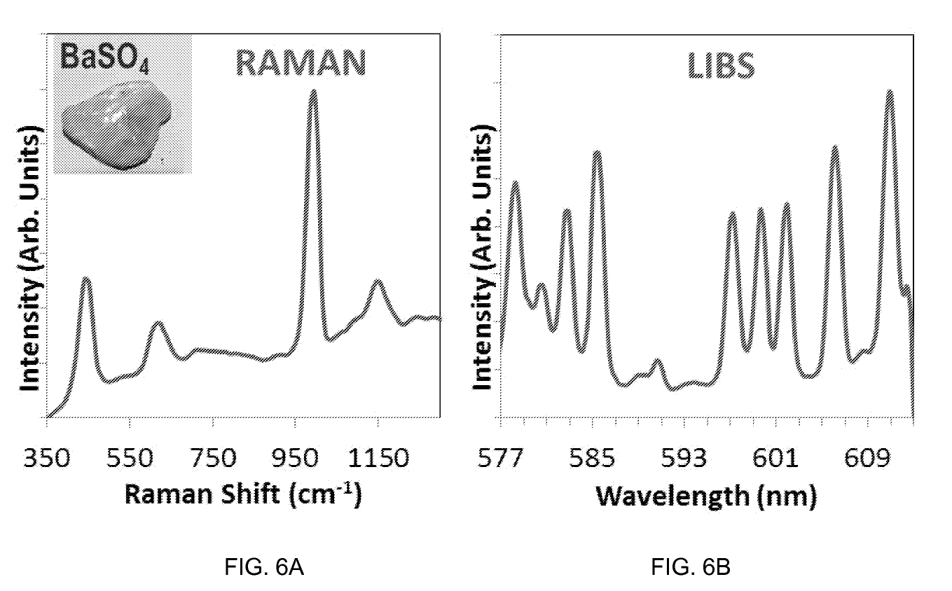

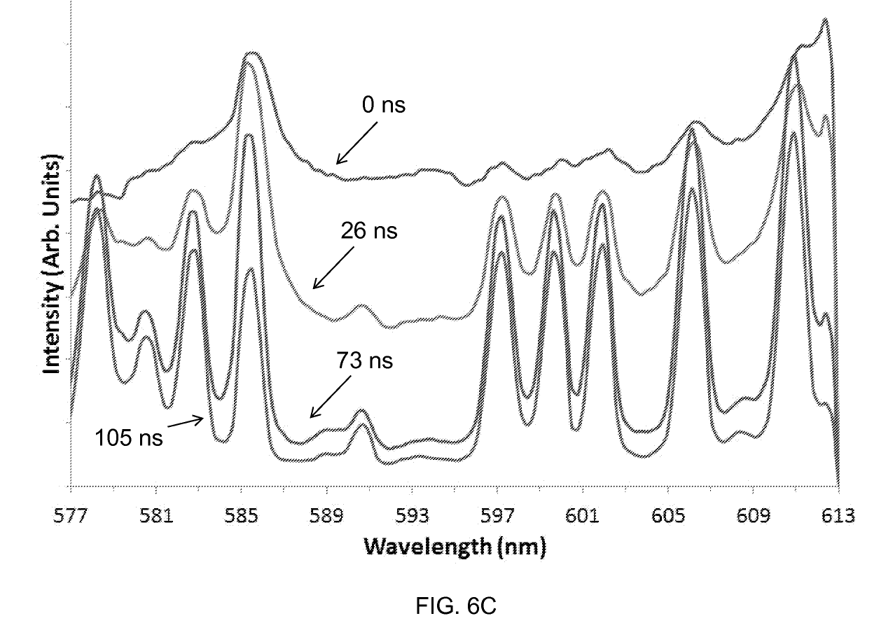

FIG. 6A is a Raman spectrum of Barite collected using the time-resolved laser spectrometer with the 128×128 SPAD array of FIG. 1B.

FIG. 6B is a LIBS spectrum of Barite collected using the time-resolved laser spectrometer with the 128×128 SPAD array of FIG. 1B. The instrumentation used to collect both spectra is identical. The only change in conditions between the two spectra is the laser power (˜10× higher for the LIBS spectrum).

FIG. 6C is a graph showing a series of LIBS spectra of Barite taken with the SPAD array spectrometer of FIG. 1B. The data is averaged over a gate of width ˜35 ns. The delay time is measured with respect to the start of the laser pulse. The plasma background is effectively eliminated with increasing delay time.

### Microscopic LIBS Capability

This is a form of LIBS that examines a microscopic sample with lower energy and more pulses, as compared to ChemCam. Microscopic LIBS can be combined with Raman and fluorescence spectroscopy in the apparatus of FIG. 1B. Microscopic LIBS can use a lower power laser operating at about 10 μJ per pulse. This is a power level that is a factor of about 1000 times lower than ChemCam. If one uses more pulses, it is expected that one will have better observation statistics. The microscopic LIBS apparatus uses a repetition rate of the order of kiloHertz instead of a repetition rate of the order of Hertz.

The advantages of the LIBS instrument include remote elemental analysis with no sample preparation; the ability to remove dust and weathering layers with repeated laser pulses trained on the same spot; simultaneous analysis of many elements; low detection limits for a number of minor and trace elements, including Li, Sr, and Ba; rapid analysis; one laser shot can constitute an analysis, though many spectra are often averaged for better statistics, still only taking a few seconds; a small analysis spot size of <0.6 mm diameter; the ability to identify water and/or hydrated minerals; and a low power consumption resulting from very short analysis times.

### System

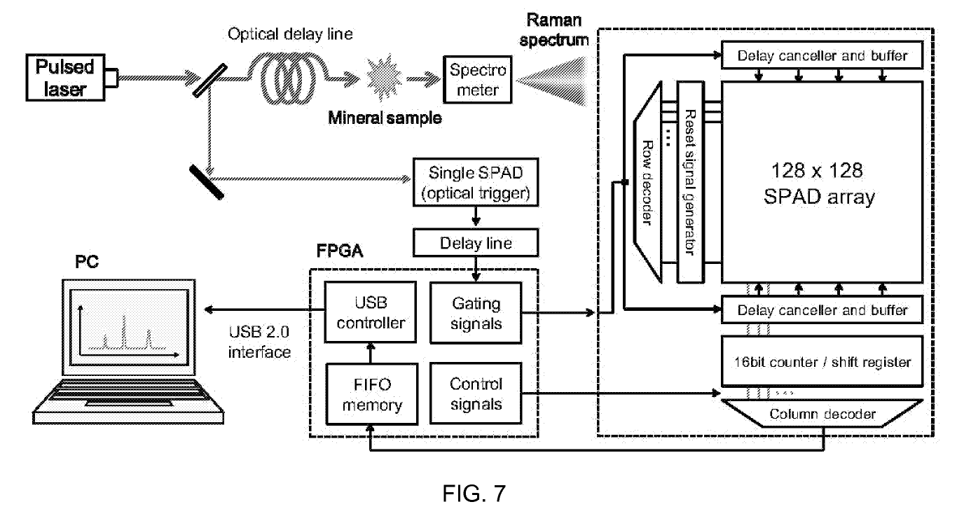

FIG. 7 is a schematic block diagram of a system that employs the time-resolved Raman spectroscopy apparatus that uses a single photon avalanche diode (SPAD) of FIG. 1B. Each pixel's state is stored in a 1-bit counter that is read out in rolling shutter mode, accumulated and serialized on-chip. The data collected is sent to a controller, such as the operation computer illustrated, via a FIFO memory and a USB communication module. Finally the data is manipulated into a form such as a spectrum (e.g., a graph of intensity vs. wavelength) which can be recorded, displayed to a user, and/or transmitted to another device.

In various embodiments, the controller can be any of an FPGA, a general purpose programmable computer having instructions recorded on a machine readable medium, and a special purpose programmable computer having instructions recorded on a machine readable medium. In various embodiments, the controller can provide input capability for a user to control the operation of the spectroscopy apparatus, or the controller can control the operation of the spectroscopy apparatus in accordance with pre-recorded instructions without the intervention of a user.

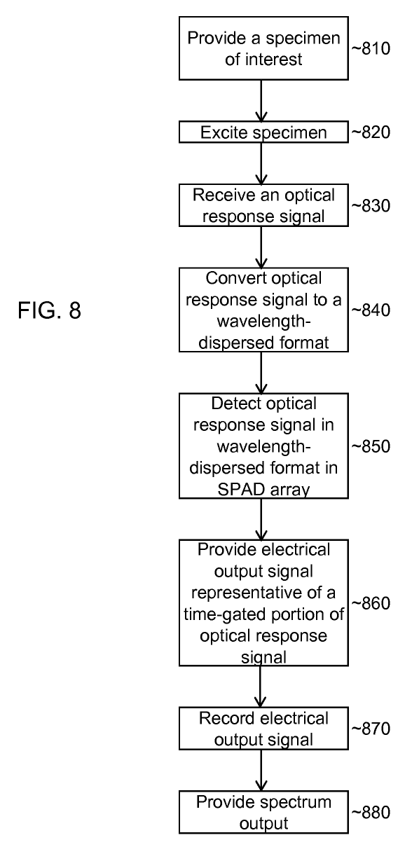

FIG. 8 is a flowchart that illustrates a method of making a time-gated spectrum using the spectroscopy apparatus of FIG. 1B. At step 810, one provides a specimen of interest from which a spectrum is desired. At step 820, one illuminates the specimen with an optical excitation signal. At step 830, one receives an optical response signal from the specimen. At step 840, one converts the optical response signal to a wavelength-dispersed format. At step 850, one detects the optical response signal in the wavelength-dispersed format in a single photon avalanche diode array that is triggered in synchrony with the optical excitation signal. At step 860, one provides an electrical output signal representative of a time-gated portion of the optical response signal in the wavelength-dispersed format. At step 870, one records the electrical output signal. At step 880, one provides the recorded electrical output signal in the form of a spectrum output.

### DEFINITIONS

Unless otherwise explicitly recited herein, any reference to an electronic signal or an electromagnetic signal (or their equivalents) is to be understood as referring to a non-transitory electronic signal or a non-transitory electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

TABLE 2

| | Type I | Type II | Unit |
|---|---|---|---|
| Array format | 1024 × 8 | | |
| Chip size | 24.7 × 0.8 | 24.7 × 1.2 | mm |
| Pixel pitch | 24 | | μm |
| SPAD breakdown | 20.4 | 19.6 | V |
| voltage | | | |
| Fill factor | 4.9 | 44.3 | % |
| (calculated from | | | |
| p+/nwell | | | |
| junction area) | | | |
| Dark count rate | 80 (Vₑ = 3 V) | 5.7k (Vₑ = 3 V), | Hz |
| | | 43k (Vₑ = 5 V) | |
| Minimum gate | 1.75 (Vₑ = 3 V) | 0.7 (Vₑ = 3 V) | ns |
| width (FWHM) | | | |
| Dark count | 1.4 × 10⁻⁵ | 4.0 × 10⁻⁴ | % |
| probability per | | | |
| gating at min. | | | |
| gate width | | | |
| Photon detection | 0.3 (Vₑ = 3 V) | 9.6 (Vₑ = 3 V), | % |
| efficiency | | 19.3 (Vₑ = 5 V) | |
| (PDE) at 465 nm | | | |
| Gating rep. rate | 1 to 950 | | cycle/sec |
| Vdd voltage | 3.3 | | V |
| Current | 81 | 0.4 | mA |
| dissipation | | | |
| (Vdd) | | | |

| | | |
|---|---|---|
| Delay range | 0 to 32 (typical) | ns |
| Temporal | 250 | ps |
| resolution | | |
| Delay line DNL | 68 (0.27 LSB) | ps |
| (0 to 32 ns) | | |
| Delay line INL | 223 (0.89 LSB) | ps |
| (0 to 32 ns) | | |

What is claimed is:

1. A time-gated spectroscopy apparatus, comprising:
an illumination source configured to provide an optical excitation signal to excite a specimen of interest so as to generate an optical response signal;
a trigger signal source configured to provide a trigger signal in synchrony with said optical excitation signal;
a spectrometer configured to receive said optical response signal and to provide said optical response signal in a wavelength-dispersed format;
a single photon avalanche diode array configured to receive said optical response signal in said wavelength-dispersed format, configured to trigger in response to said trigger signal, and configured to provide an electrical output signal representative of a time-gated portion of said optical response signal in said wavelength-dispersed format;
a signal recorder configured to record said electrical output signal; and
a controller configured to control said illumination source, said single photon avalanche diode array, and said signal recorder, and configured to provide said recorded electrical output signal in the form of a spectrum output.

2. The time-gated spectroscopy apparatus of claim 1, wherein said illumination source is a pulsed laser.

3. The time-gated spectroscopy apparatus of claim 1, wherein said single photon avalanche diode array is configured to be triggered with a time resolution as short as tens of nanoseconds.

4. The time-gated spectroscopy apparatus of claim 1, wherein said single photon avalanche diode array is configured to be triggered with a time resolution as short as units of nanoseconds.

5. The time-gated spectroscopy apparatus of claim 1, wherein said single photon avalanche diode array is configured to be triggered with a time resolution as short as picoseconds.

6. The time-gated spectroscopy apparatus of claim 1, wherein said controller is configured to provide said recorded electrical output signal in the form of a Raman spectrum.

7. The time-gated spectroscopy apparatus of claim 1, wherein said controller is configured to provide said recorded electrical output signal in the form of a laser-induced breakdown spectrum.

8. The time-gated spectroscopy apparatus of claim 1, wherein said single photon avalanche diode array is an array having M×N pixels, where M and N are integers greater than 1.

9. The time-gated spectroscopy apparatus of claim 1, wherein said controller is a microprocessor-based controller.

10. The time-gated spectroscopy apparatus of claim 9, wherein said microprocessor-based controller is selected from the group of controllers consisting of a FPGA, a general purpose programmable computer having instructions recorded on a machine readable medium, and a special purpose programmable computer having instructions recorded on a machine readable medium.

11. The time-gated spectroscopy apparatus of claim 1, wherein said trigger signal source provides an electrical trigger signal.

12. The time-gated spectroscopy apparatus of claim 1, wherein said trigger signal source provides an optical trigger signal.

13. A time-gated spectroscopic method, comprising the steps of:
providing a specimen of interest from which a spectrum is desired;
illuminating said specimen with an optical excitation signal;
receiving an optical response signal from said specimen;
converting said optical response signal to a wavelength-dispersed format;
detecting said optical response signal in said wavelength-dispersed format in a single photon avalanche diode array that is triggered in synchrony with said optical excitation signal to provide an electrical output signal representative of a time-gated portion of said optical response signal in said wavelength-dispersed format;
recording said electrical output signal; and
providing said recorded electrical output signal in the form of a spectrum output.

14. The time-gated spectroscopic method of claim 13, wherein said illuminating is provided by a pulsed laser.

15. The time-gated spectroscopic method of claim 13, wherein said single photon avalanche diode array is configured to be triggered with a time resolution as short as tens of nanoseconds.

16. The time-gated spectroscopic method of claim 13, wherein said single photon avalanche diode array is configured to be triggered with a time resolution as short as units of nanoseconds.

17. The time-gated spectroscopic method of claim 13, wherein said single photon avalanche diode array is configured to be triggered with a time resolution as short as picoseconds.

18. The time-gated spectroscopic method of claim 13, wherein said recorded electrical output signal is provided in the form of a Raman spectrum.

19. The time-gated spectroscopic method of claim 13, wherein said recorded electrical output signal is provided in the form of a laser-induced breakdown spectrum.

20. The time-gated spectroscopic method of claim 13, wherein at least one of said illuminating, receiving, converting, detecting, recording and providing said recorded electrical output signal in the form of a spectrum output steps is controlled by a microprocessor-based controller.
